(19) United States
(12) Patent Application Publication
(10) Pub. No.: US 2015/0375107 A1
(43) Pub. Date: Dec. 31, 2015

(54) GAME APPARATUS

(71) Applicant: PARTY PEOPLE GAMES LLC, Portland, OR (US)

(72) Inventor: Matthew FEINBERG, Portland, OR (US)

(21) Appl. No.: 14/314,965

(22) Filed: Jun. 25, 2014

(51) Int. Cl. A63F 13/212

(52) U.S. Cl. CPC A63F 13/212

(57) ABSTRACT

A gameplay apparatus including at least one wearable component and at least one game sign. The at least one game sign is configured to be detachably attached to the wearable component, and the wearable component with detachably attached game sign can be worn during gameplay. The at least one game sign may include an image and/or text that may be related to the actions to be taken during gameplay.

### BACKGROUND

Interactive games, in various forms, may serve useful educational, entertainment or other purposes. Interactive games such as those in U.S. Pat. No. 3,524,645 and U.S. Pat. No. 6,053,490 are designed for enjoyment and include a plurality of cards to be utilized in various forms.

### SUMMARY

The present application is directed to a game apparatus. The game apparatus may include a plurality of game signs related to gameplay each including at least one of a graphic or text, and a wearable component. The wearable component may be configured to allow for at least one of the plurality of game signs to be detachably attached to the wearable component. Each of the plurality of game signs may relate to, directly or indirectly, an action to be taken by a player wearing a respective one of the plurality of game signs during the gameplay.

In some embodiments, the game apparatus includes a plurality of game signs each including at action to be taken by a player, and a wearable component. At least one of the plurality of game signs may be configured to be detachably attached to the wearable component, and the player may gain a reward upon completion of the action to be taken.

In some embodiments, the game apparatus includes a plurality of game signs related to gameplay each including at least one of a graphic or text, and a wearable component. The wearable component is worn on a player's neck, at least one of the plurality of game signs may be detachably attached to the wearable component, and each of the plurality of game signs relate to, directly or indirectly, an action to be taken by a player wearing a respective one of the plurality of game signs during gameplay.

### BRIEF DESCRIPTION OF THE DRAWINGS

FIGS. 1A-1E show examples of a game sign according to one or more aspects.

FIGS. 2A-2D show examples of the game sign and wearable component according to one or more aspects.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the apparatus described herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, the subject matter of this application illustratively disclosed herein suitably may be practiced in the absence of any element(s) that are not specifically disclosed herein.

The following definitions are provided in order to aid those skilled in the art in understanding the detailed description.

As used herein, the term “game sign” refers to any object that conveys an image and/or word or series of words on its face. The sign may be made of any suitable material, including metal, plastic, wood, paper and the like. Further, while one skilled in the art will appreciate that the game sign as used herein may be used in a gameplay situation, it will be understood that the use of such a game sign is not restricted to gameplay, and such a game sign may be used in any appropriate location and situation.

As used herein, the term “wearable component” refers to any component with the capability of being worn on a person's body. Such a wearable component may be a string or elastic, and may be an infinite loop or may have at least two ends. In some embodiments, the wearable component is configured to be placed on one's neck, but the use of this term is not to be so limited. Suitable wearable components may be, for example, a headband, bracelet, necklace, anklet, or belt. The wearable component may be slipped onto a person's body without the need for any fastening, or may be detachable and fastenable.

As used herein, the term “playing surface” refers to any surface whereby gameplay can occur. Suitable playing surfaces may be a predesigned game board, or any other surface capable of allowing a player's progression through a game to be tracked.

The present application relates to a game apparatus that may be utilized during gameplay.

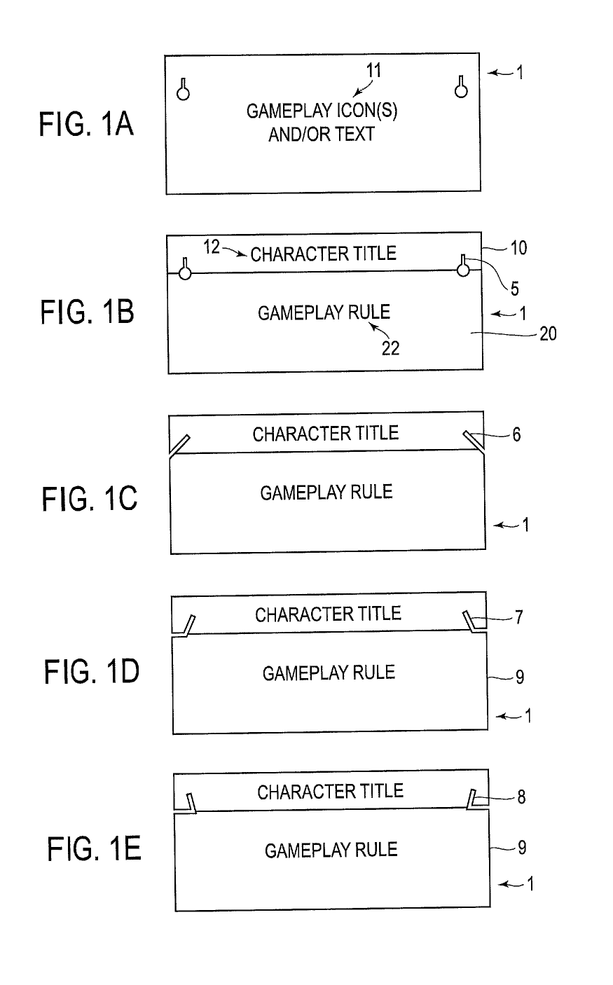

Referring to FIGS. 1A-1E, a game sign 1 is shown. The game sign may be a single portion and include one or more icons or text 11, as shown in FIG. 1A.

The game sign 1 may also be split into multiple portions, such as the upper portion 10 and lower portion 20 as shown in FIGS. 1B-1E. The upper portion 10 may include an icon or title of a character, and thus may be considered a “character title,” as shown by character title 12. The character title may be an image or text that may differentiate one game sign from another. The character title on the game sign may inspire a player to play a role of a specific character during gameplay. The lower portion 20 may include a gameplay rule 22. The gameplay rule may be a rule that a player holding the game sign is required to or requested to perform during gameplay.

The game sign 1 may be configured to be attached to one or more other components such as a wearable component. The method of attachment may utilize any suitable attachment element and may be by any suitable method to ensure that the game sign 1 is detachably attached to the component. As shown in FIG. 1B, the game sign 1 may include one or more attachment components, here shown as circular holes 5, such as keyholes, configured to allow for detachable attachment of the game sign 1 to a component. The size of the holes is not particularly limited, provided that the holes are suitable for allowing detachable attachment of the game sign to a component.

FIGS. 1C, 1D and 1E show other arrangements to allow for the detachable attachment of the game sign 1 to the component. In FIG. 1C, the game sign 1 includes a plurality of slits 6, 7, 8 configured to allow for attachment of the game sign 1 to a component by means of attachment elements. The slits may be slanted as shown in FIG. 1C, or may be substantially horizontal or even substantially vertical with respect to the game sign. Slits 6 are positioned to enable the component to be detachably attached to the game sign 1. The slits may be about 1 to about 20 mm in length, or about 10 mm in length and may or may not reach the edges of the game sign 1.

In FIGS. 1D and 1E, the game sign 1 includes a plurality of slits 7 and 8, respectively, the slits each including a slanted portion and a linear portion. The slanted component may be slanted toward a center portion of the game sign 1, as shown in FIG. 1D, or slanted toward the lateral end of the game sign 1, as shown in FIG. 1E. The linear component may be parallel to the longitudinal face of the game sign. The linear components and the slanted component of the slits 7 and 8 may or may not reach the edges of the game sign. In some embodiments, the linear component of the slits 7 and 8 reaches an edge of the game sign, such as the lengthwise edge 9.

In the above-described embodiments, the slits 6-8 and the holes 5 may serve as the attachment element. That is, the slits 6-8 and holes 5 may be capable of allowing detachable attachment of the game sign 1 to the component. Additionally or alternatively, the slits 6-8 and holes 5 may work in conjunction with an additional attachment element to allow for detachable attachment of the game sign 1 to the component.

The above-described Figs. only show exemplary embodiments of the game sign. It should be understood that, for example, the design and location of the holes and/or slits is not limited, provided that the holes or slits allow for detachable attachability of the game sign 1 to another component.

The game sign may have any suitable area and is not particularly limited in shape, provided that the game sign allows for the inclusion of one or more of an image and text. In some embodiments, the game sign is large enough to be viewed from a distance of 5 feet, or 10 feet, or even 20 feet or more. Further, in some embodiments, the game sign is large enough to be worn as an attachment to a necklace and worn around a person's body while still being readable from the above-described distances. The area of the game sign may be, for example, about 10 to about 50 square inches, or about 12 to about 50 square inches, or from about 25 to about 35 square inches, or about 35 to about 50 square inches. The game sign may be about 3 to about 5 inches in width and about 4 to about 10 inches in length/height.

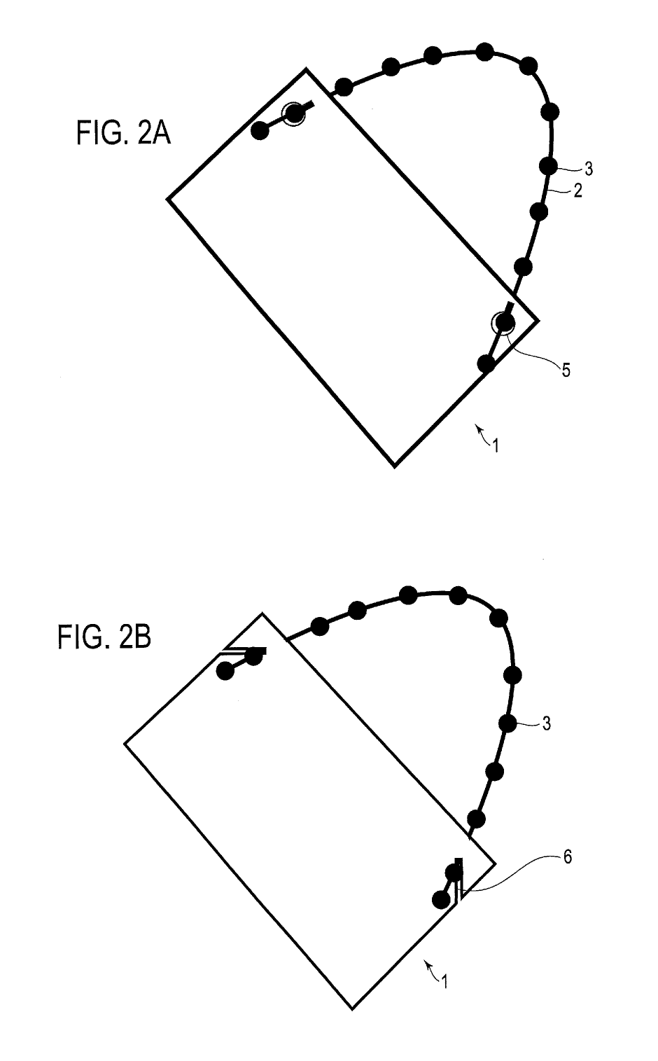

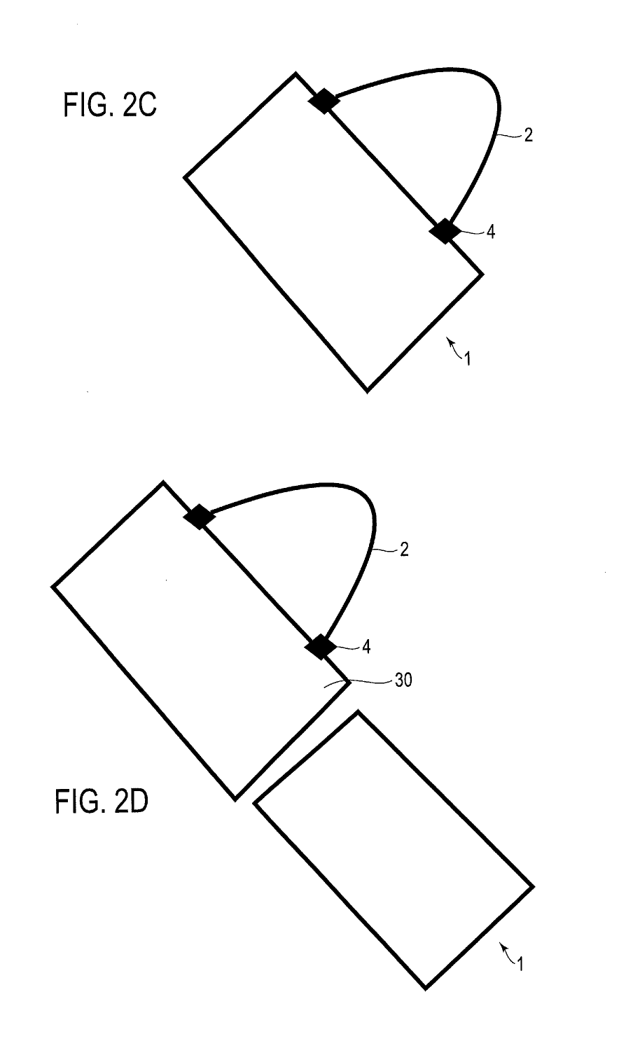

FIGS. 2A and 2B depict a game sign 1 according to FIGS. 1A-1E, and further show the game sign 1 being detachably attached to a component. The component shown in FIGS. 2A and 2B may be a wearable component 2. The wearable component may be a string, elastic, or any other component that is capable of withstanding the weight of the game sign 1 when the game sign 1 is attached. The wearable component may include yarn, plastic, metal, fabric, leather or other materials. The wearable component may be of a length long enough to be worn around a person's neck, or any other body portion. The wearable component may be substantially linear in nature. In this situation the wearable component may rest around a person's body part, even without any attachment of the game sign. Suitable lengths of such a wearable component 2 may be about 20 to about 50 inches, or about 24 to about 42 inches, or from about 30 to about 36 inches. The wearable component 2 may also be fully circular and infinitely continuous in nature, and be attachable to the game sign 1 by one or more of the attachment techniques described herein.

As can be seen in FIGS. 2A and 2B, the wearable component 2 may include 1 or more fixable components 3 that are capable of being fixedly attached to the wearable component. Such fixable components may include beads, stoppers, jewels, or other relatively small structures. The fixable components may serve to mechanically strengthen the wearable component, may improve aesthetic appearance, or both.

FIG. 2C depicts a game sign 1 according to FIGS. 1A-1E, and includes a fastener 4 as an attachment element for detachably attaching the game sign 1 to the wearable component 2. The fastener may be fully capable of providing detachable attachment of the game sign 1 to the wearable component 2, or may work in conjunction with one or more other attachment elements, including but not limited to the holes 5 and slits 6-8 shown in FIGS. 1B-1E.

FIG. 2D further includes a housing 30 to support and/or hold the game sign 1. The housing 6 may be configured to allow for the game sign 1 to be slided into, affixed onto, or otherwise detachably or fixedly attached to the housing. The housing 30 or game sign 1, or both, may be detachably attached to the wearable component 2 by means of one or more fasteners.

The fasteners may be any suitable component that can appropriately allow for detachable attachment of the game sign 1 to the wearable component 2. This includes, but is not limited to binder clips, paper clips, Velcro, magnets, hooks and buttons or the like. Fasteners can further include one or more of metal, plastic, wood, or any suitable material. Additionally, a fastener comprising a mechanical mold that can mechanically clamp onto the game sign 1 and/or housing 6, and or fits into holes such as circular hole 5 or slits such as slits 6-8 can be utilized to aid in detachable attachment of the game sign 1 to the wearable component 2.

The plurality of game signs may have a relationship to the game, for example to the gameplay. In an embodiment where gameplay is directed to a game involving social interaction, the plurality of game signs may each be related to the gameplay insofar as the signs will include text and/or graphics that correspond to actions to be taken at some point in the game. The plurality of game signs thus may each be related to gameplay by providing, for example, enough information for a player to understand what action during gameplay must be taken when such a game sign is worn on the player's body.

The game apparatus may further include at least one playing surface. The playing surface may be, for example, a game board or any other surface capable of providing a medium for gameplay. The playing surface may include a plurality of spaces, and players may be able to move along the playing surface (e.g., through the plurality of spaces). The players may move along the playing surface using a game piece that may be, for example, a small token. The game piece is not limited in size or shape.

In embodiments where a game board is used, players or their respective game piece may move along the game board during the progression of the game. Players may move along the game board based upon, a roll of one or more die or a selection of one or more cards or the like. Players may further advance along the game board in response to actions necessitated or suggested by the game itself, including but not limited to an action suggested by the player's respective one or more game signs.

If and when a player completes an action suggested by the one or more game signs, the player may receive a reward. The reward may be an action to move the player ahead in the game, such as moving additional spaces along the playing surface, or may be an unrelated reward, such as a consumable (e.g., food or beverage) or another prize.

In some embodiments, all players will be wearing a wearable component with one or more game signs detachably attached. As a condition of gameplay, and/or as necessitated by one or more actions during the course of the game, a particular player may be required or requested to perform an action that is related to, directly or indirectly, the graphic and/or text on his game sign.

In some embodiments, the wearable component plus the detachably attached game sign will be worn around a player's neck during gameplay. The player may be aware of the content of the game sign worn around his neck, and thus may be aware of the gameplay-related action to be taken. Alternatively, the player may be unaware of the content of the game sign worn around his neck, and may need to determine which gameplay-related action that needs to be taken by, for example, interacting with other players.

As a nonlimiting example provided to allow one skilled in the art a more comprehensive understanding of gameplay, a first player may be wearing a first wearable component and a first game sign, the first game sign having a gameplay rule such as “Lie whenever another player asks you a personal question.” A second player may be wearing a second wearable component and a second game sign, the second game sign having a gameplay rule such as “Other players must compliment you on your fashion choices.” During gameplay, the first player may roll one or more die and land on a square of the playing surface, the square indicating that the first player must talk to the second player for a period of time (e.g., about 15 seconds or about 30 seconds or about one minute or more). The first player may then initiate a conversation with the second player, the second player may ask the first player a question, and the first player may respond to the second player with a false statement. The first player may further compliment, for example, the second player's shoes. In this case, both players will have accomplished the tasks suggested by their game signs, and will be rewarded.

In other embodiments, the game sign may include only a graphic, such as an image of a dog, or text, such as “dog.” At certain times during gameplay, the player wearing such a game sign along with his wearable component may take actions related to the image and/or text, in this case, barking like a dog or moving like a dog or the like.

Further, at any time during the game, or at specific times during the game, including, for example, after a task is completed or after reaching a space on a playing surface instructing a player to do so, a player may change his one or more game signs by replacing the game sign affixed to his wearable component with another game sign. The player will unfasten and/or remove his detachably attachable game sign from his wearable component, and proceed to attach and/or fasten a new detachably attachable game sign from his wearable component. In some cases, a player take his new game sign from another player, and in other cases, a player may take his new game sign from an unused group of game signs. The unused group of game signs may be face-up, so that the player is aware of the possible new game signs prior to selection, or face-down, where the player must blindly choose a new game sign.

During gameplay a player may talk, either alone or to one or more players. A player wearing a game sign may be required or requested to follow a specific game rule until a predetermined time, such as about 30 seconds or about one minute has passed. A player wearing a game sign may also be required or requested to follow a specific game rule until a specific game motion, such as rolling dice or drawing a card has occurred. Such a game motion may provide for the player to remove his game sign and give it to another player, or otherwise for the player to acquire a different game sign.

A player or team of players may complete the game once the player or one or more of the members of the team of players complete a certain number of tasks, and/or reach a final space on the playing surface. Players may identify which players are on their respective team or are trying to accomplish similar actions or goals based upon the game sign that a player is wearing. The game sign may further include an indicator to aid players playing the game to recognize those players on their respective team or are trying to accomplish similar actions or goals.

Although the preceding description has been described herein with reference to particular means, materials and embodiments, it is not intended to be limited to the particulars disclosed herein; rather, it extends to all functionally equivalent structures, methods and uses, such are within the scope of the appended claims.

What is claimed is:

1. A game apparatus, comprising:
a plurality of game signs related to game play, each including at least one of a graphic or text; and
a wearable component,
wherein the wearable component is configured to allow for at least one of the plurality of game signs to be detachably attached to the wearable component, and
wherein each of the plurality of game signs relate to, directly or indirectly, an action to be taken by a player wearing a respective one of the plurality of game signs during gameplay.

2. The game apparatus according to claim 1, wherein the wearable component comprises a string or elastic.

3. The game apparatus according to claim 1, further comprising at least one fixable component fixedly attached to the wearable component.

4. The game apparatus according to claim 3, wherein the at least one fixable component includes beads and/or stoppers.

5. The game apparatus according to claim 1, wherein at least one of the plurality of game signs is detachably attached to the wearable component.

6. The game apparatus according to claim 5, wherein at least one of the plurality of game signs is detachably attached to the wearable component by means of an attachment element.

7. The game apparatus according to claim 6, wherein the attachment element is a fastener selected from the group consisting of binder clips, paper clips, Velcro, magnets, hooks and buttons, and combinations thereof.

8. The game apparatus according to claim 6, wherein the attachment element comprises a mechanical mold.

9. The game apparatus according to claim 8, wherein the attachment element fits into a keyhole or a slot in the sign.

10. The game apparatus according to claim 5, wherein the at least one of the plurality of game signs is detached from the wearable component and another one of the plurality of game signs is detachably attached to the wearable component in response to a gameplay action.

11. The game apparatus according to claim 1, wherein the wearable component is worn around the player's neck.

12. The game apparatus according to claim 1, wherein each of the plurality of signs measures from about 12 to about 50 square inches.

13. The game apparatus according to claim 1, further comprising at least one playing surface and at least one game piece, the at least one game piece configured to move along the at least one playing surface based upon a result of the gameplay.

14. A game apparatus, comprising:
a plurality of game signs each including at action to be taken by a player; and
a wearable component,
wherein at least one of the plurality of game signs is configured to be detachably attached to the wearable component, and
wherein the player gains a reward upon completion of the action to be taken.

15. A game apparatus according to claim 14, wherein the at least one of the plurality of game signs is detached from the wearable component and another one of the plurality of game signs is detachably attached to the wearable component after completion of the action to be taken.

16. A game apparatus according to claim 14, wherein the plurality of game signs comprises a character title.

17. A game apparatus according to claim 14, wherein the plurality of game signs comprises a gameplay rule.

18. A game apparatus, comprising:
a plurality of game signs related to gameplay, each including at least one of a graphic or text; and
a wearable component,
wherein the wearable component is worn on a player's neck,
wherein at least one of the plurality of game signs is detachably attached to the wearable component, and
wherein each of the plurality of game signs relate to, directly or indirectly, an action to be taken by a player wearing a respective one of the plurality of game signs during gameplay.

19. A game apparatus according to claim 1, further comprising a housing for supporting and/or holding the game sign.
